(19) United States
(12) Patent Application Publication
(10) Pub. No.: US 2006/0035628 A1
(43) Pub. Date: Feb. 16, 2006

(54) Weather channel

(75) Inventors: Roger Colin Miller, Sammamish, WA (US); Albert W. Tan, Redmond, WA (US); Dane M. Howard, Sammamish, WA (US); Paul J. VanderSpek, Seattle, WA (US); James W. Cooley, Redmond, WA (US); Keith C. Curtis, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 10/909,181

(22) Filed: Jul. 30, 2004

(51) Int. Cl. H04Q 1/00; H04Q 7/22

(52) U.S. Cl. 455/414.3; 455/414.1

(57) ABSTRACT

The present invention provides a weather channel that provides a user of a mobile electronic device simple access to weather information, such as local weather, national and international weather, user selected cities, as well as weather alerts and messages. The user may customize the weather content they receive on their devices. Users are able to view weather information based on their preferences. While using the weather channel, users automatically receive broadcast weather information, including local weather information (current temperature, forecast information, sunset, sunrise, humidity, UV index, and the like); selected city information, national and international weather, and weather alerts and messages that are easy to navigate.

### BACKGROUND OF THE INVENTION

Mobile electronic devices, such as cell phones, wireless PDAs, wireless laptops and other mobile communication devices are making impressive inroads with consumers. Many of the mobile electronic devices are able to perform a variety of tasks and include a user interface to help the user access the features associated with the device. For example, some mobile devices include a display unit that displays graphical data to support email, instant messaging, web browsing, and other non-voice features. Using their mobile devices, users access the Internet, send and receive email, participate in instant messaging, and perform other operations. Accessing the desired information, however, may be cumbersome for the user. When accessing the Internet, for instance, users have to log onto the network and then type in information to access the information they desire. Additionally, using the user interface to access the information may be difficult.

### SUMMARY OF THE INVENTION

The present invention is directed at providing a weather channel that includes weather content delivered to a user on a mobile device.

According to one aspect of the invention, weather content associated with the weather channel is automatically delivered and stored on a mobile electronic device for access by a user. Using the device, users can quickly access the weather information they are interested in without having to type in information to specifically download the weather content to the device. The weather channel is directed at providing a quicker and less cumbersome way of accessing weather information as compared to having to access a web site or listen to the radio.

According to another aspect of the invention, the weather channel includes several different modes for categorically displaying different types of weather information. Some example modes include: a local weather mode; a My Cities mode; a North American mode, and an International Weather mode.

According to yet another aspect of the invention, the user may customize the weather information they receive on their device. For example, using a web interface, the user may select cities on which to receive weather information.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 illustrates an operating environment;

FIG. 2 shows an electronic device;

FIG. 3 illustrates an exemplary smart object watch devices that include a user interface for navigating through channels and content;

FIG. 4 illustrates a system for delivering and configuring channel information to an electronic device;

FIGS. 5A-5D illustrate process flows for passive and active navigation functions of a electronic device;

FIG. 6 shows exemplary status indicator headers;

FIG. 7 illustrates exemplary modes for a weather channel;

FIG. 8 illustrates a local weather mode;

FIG. 9 illustrates a My Cities mode;

FIG. 10 illustrates a North America mode;

FIG. 11 shows an International mode;

FIG. 12 illustrate a web user interface for inputting user preferences for a weather channel; and

FIG. 13 illustrates encoding weather data, in accordance with aspects of the present invention.

### DETAILED DESCRIPTION OF THE PREFERRED EMBODIMENT

The apparatus, system, and method of the present invention are related to navigating through weather content on a device that includes stored weather related information. The weather content may be selected and viewed on a display of the device by means of passive interaction (e.g., hands free operation) or active interaction (e.g., selecting buttons).

In the described embodiments, the electronic devices may be mobile devices, such as smart watches, that are specially configured to receive communication signals. The electronic devices may be configured to receive broadcast transmissions from one or more broadcast towers and are capable of receiving and processing messages from the broadcast transmissions.

The electronic devices store the received information such that the information is indexed according to designated channels. Each channel includes content that is organized according to a set of criteria. For example, weather content is presented in one channel; wherein sports content is presented in another channel. Some channels may include content from one or more of the other channels. For example, a messages channel may include weather related alerts and news. After information is received and processed by the client device, a user may passively or actively review the information that is stored in the electronic device.

One of the particular channels corresponds to a weather channel. The weather channel on each device may be customized based on user preferences such that the user experience is enhanced. An example weather channel may be configured to display weather content for a user's local region in addition to national and international weather and selected cities that a user has selected to receive weather information about.

Although described here in the context of a watch-based system, other mobile or non-mobile devices, such as portable and desktop computers, personal digital assistants (PDAs), cellular telephones, and the like, may be used. The use of a watch is for illustrative purposes only to simplify the following discussion, and may be used interchangeably with “mobile device” and/or “electronic device”.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

Weather Channel

The weather channel is arranged to provide a user of a mobile electronic device simple access to weather information, such as local weather, national and international weather, user selected cities, as well as weather alerts and messages. The user may customize the weather content they receive on their devices. The user preferences and weather information may be provided as information that is retrieved from broadcast transmissions such as described herein.

Users are able to view weather information based on their preferences. While using the weather channel, users automatically receive broadcast weather information, including local weather information (current temperature, forecast information, sunset, sunrise, humidity, UV index, and the like); selected city information, national and international weather, and weather alerts and messages that are easy to navigate.

The user interface is directed at providing a simple, easy way to access the weather content that is pushed to the device. Updates to the weather content on the device occur automatically. Additionally, the user can request to receive weather information on selected cities that they care about.

Exemplary Smart Object Device

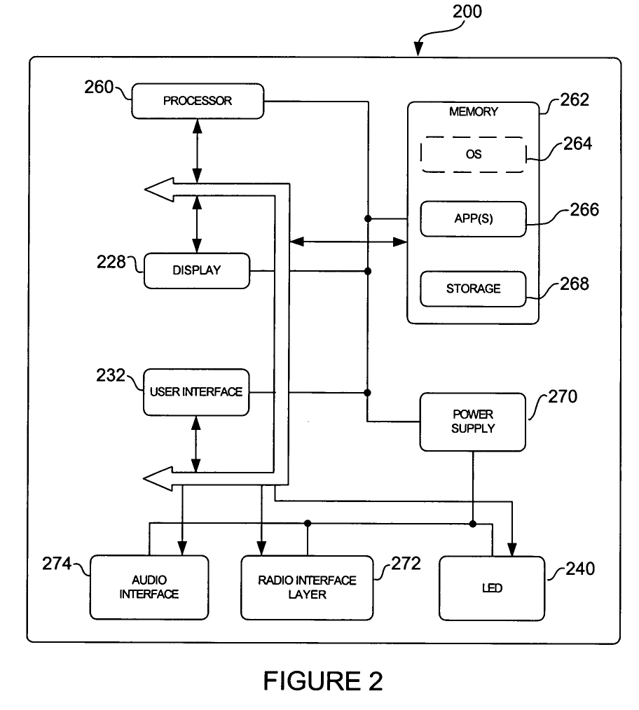

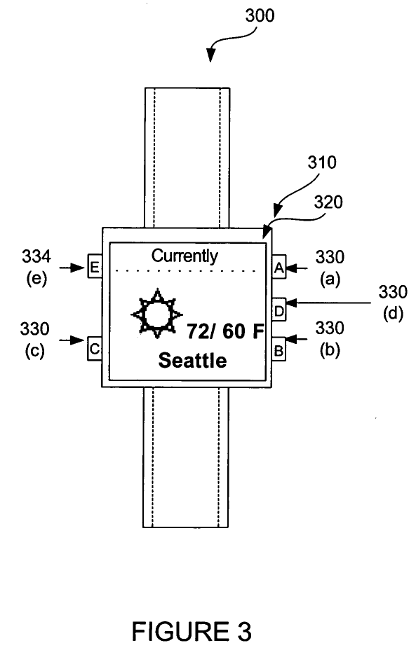

FIG. 3 illustrates an exemplary smart device that includes a user interface that is configured to interact with content from channels, in accordance with aspects of the invention. Watch device 300 includes bezel 310 which has an electronic system. The electronic system performs the functions in a manner that is consistent with the hardware that is described with respect to FIG. 2. Bezel 310 includes display 320, such as a liquid crystal display, a multiple bit display, or a full color display. In one embodiment, watch hands are electronically generated on display 320 when the user is in a time mode. In an alternative embodiment, the bezel includes analog-type watch hands that do not detrimentally interfere with display 320. As illustrated, display 320 shows a view in a weather channel for the current weather conditions in Seattle, Wash.

Watch device 300 includes a series of selectors, such as buttons A-D (330a-d), which are arranged to operate as part of a user interface (UI). Each selector may have a default function and/or a context determined function. The currently selected channel determines the context for each selector. Alternatively, the currently active display may determine the context for each selector. For example, a display screen (e.g., a help screen) may be superimposed on the main display such that the display screen becomes the active context. Watch device 300 is context sensitive in that the function that is associated with each selector may change based on the selected channel or display screen.

Button “A” has a default function of page up or previous page in the currently selected channel. Button “A” may also have an alternate function based on the currently selected channel or display. Button “B” has a default function of page down or next page in the currently selected channel. Button “B” may also have an alternate function based on the currently selected channel or display. In one example, button “B” is activated for a predetermined time interval (e.g., two seconds) to select a “speed list browse” function.

Button “C” has a default function of next channel. Button “C” may also have an alternate function based on the currently selected channel or display. In one example, button “C” is activated for a predetermined time interval (e.g., two seconds) to select the main channel or “primary” channel. The main channel in an example watch device is the time channel that provides the user with time related information. However, devices may be configured to have some other display screen that is recognized by the device as a “primary” channel or “home” location.

Button “D” has a default (or “primary”) function of “enter.” The “enter” function is context sensitive and used to select the “enter” function within a selected channel (e.g., enter My Cities mode), or to select an item from a selection list (e.g., select a city). Button “D” may also have an alternate function based on the currently selected channel or display. For example, the “D” selector is activated for a predetermined time interval (e.g., two seconds) to activate a delete function. In another example, the “D” button may be selected for a predetermined time to activate a help screen or an additional set mode. In this example, the help screen remains active while button “D” is activated, and the help screen is deactivated (e.g., removed from the display) when the “D” button is released. According to another embodiment, the “D” button may also perform another function; such as showing the date or time; initiating a custom action/animation; and the like.

The selectors are arranged such that the electronic device accomplishes navigating and selecting content on each channel in a simple manner. An optional fifth selector (e.g., button “E”) may be arranged to provide other functions such as backlighting or another desired function. Other selectors may also be included.

Exemplary Weather Channel Modes

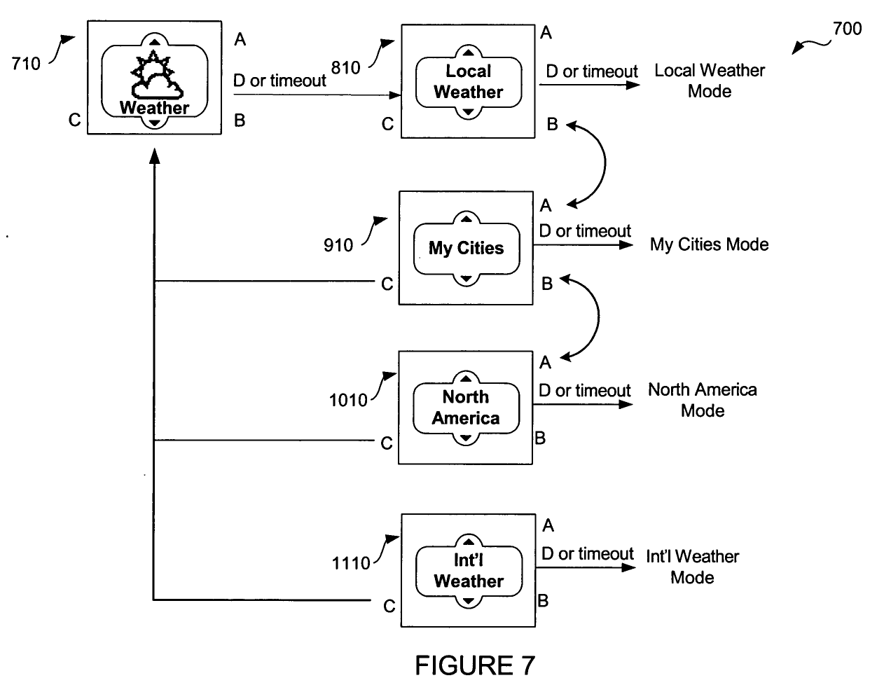

FIGS. 7-11 are diagrams illustrating example views for various modes associated with a weather channel that is arranged in accordance with the present invention.

FIG. 7 shows operating modes 700 associated with a weather channel, in accordance with aspects of the invention. The weather channel may be configured for multiple operating modes. According to one embodiment, the weather channel includes four modes: a local weather mode (810); a My Cities mode (910); a North America mode (1010); and an International Weather mode (1110). Weather alerts and news is also provided to the device.

Weather channel splash-screen 710 is displayed when the weather channel is initially selected. After the weather channel is selected, one of the available modes is activated by the expiration of a timeout period (e.g., two seconds) without user interaction, or by activation of the “D” or “enter” selector. The channel splash may also be activated from any one of the mode splash screens by activation of the “C” selector.

A mode splash-screen may be displayed whenever the mode is changed on the device. In one example, the mode may be changed by selective activation of the next and previous selectors (e.g., the “B” and “A” buttons) when any mode splash screen is active. The mode splash screen may be dismissed via a timeout condition or by activation of the “D” selector (or enter function). Each mode has a series of associated views.

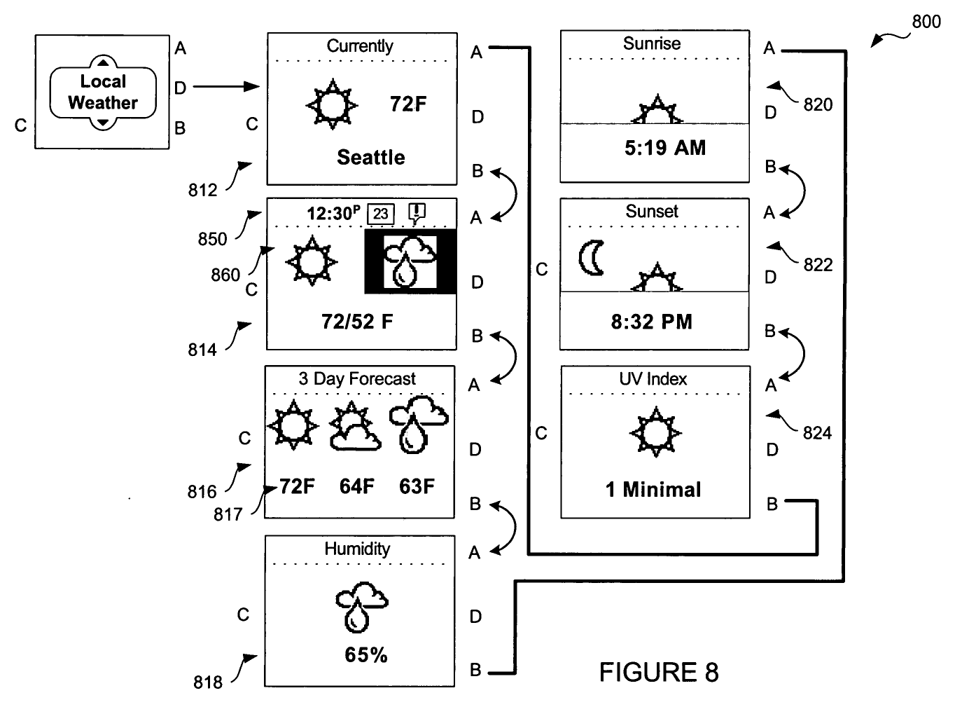

The channel splash-screen is dismissed after a mode is activated. When the local weather mode is activated, local weather splash screen 810 may be displayed. According to one embodiment, the device immediately enters the local weather mode without displaying splash screen 810. Generally, the local weather mode of the channel includes many display views that correspond to the local weather for a city within a user's home region (See FIG. 8 and related discussion).

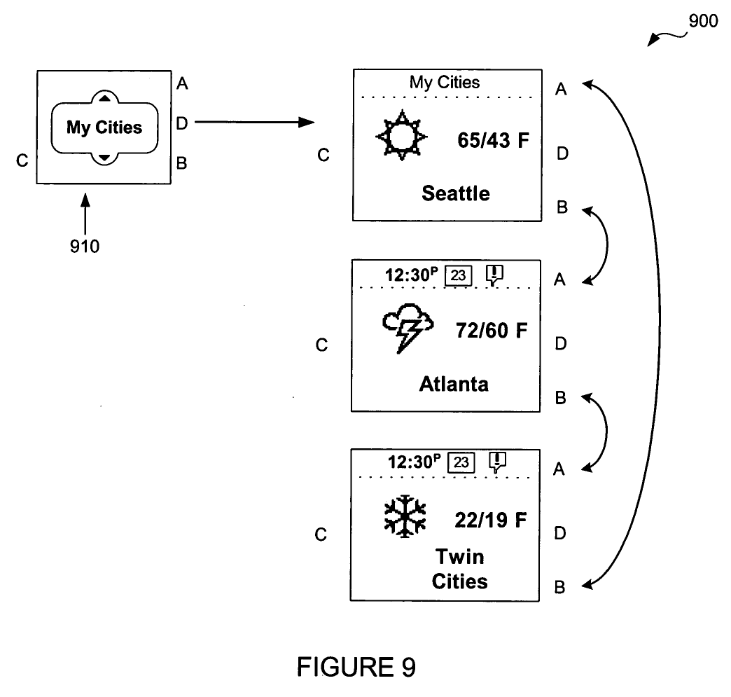

When the My Cities mode is activated, splash screen 910 is displayed. After the My Cities splash-screen is dismissed, the device enters the My Cities mode. Generally, the My Cities mode displays weather information for cities selected by a user. (See FIG. 9 and related discussion).

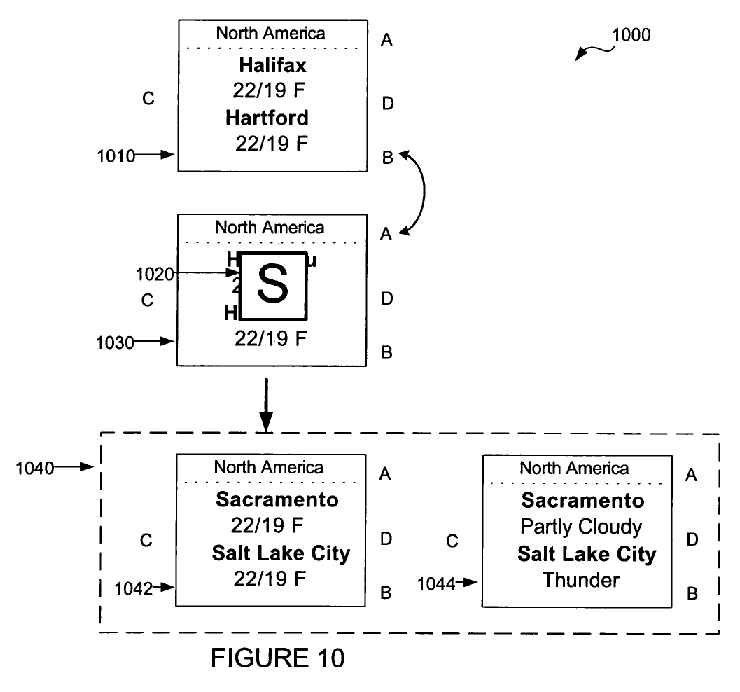

When the North America mode is activated, splash screen 1010 is displayed. After the North America splash screen is dismissed, the device enters the North America mode. Generally, the North America mode provides the user with weather information for a predetermined list of North American cities (See FIG. 10 and related discussion).

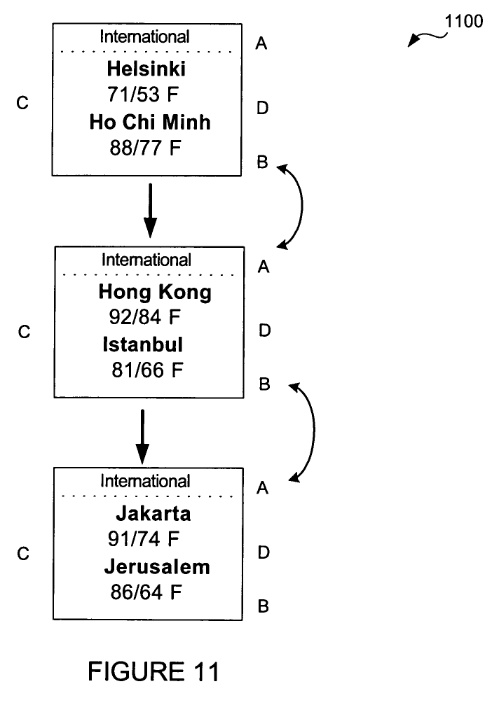

When the International weather mode is activated, splash screen 1110 is displayed. After the International weather mode splash screen is dismissed, the device enters the International Weather mode. Generally, the International weather mode provides the user with weather information for a predetermined list of international cities (See FIG. 11 and related discussion).

While in one of the weather modes, the user may select the “C” button to bring up the splash screen for the current mode. The user may then use the “A” or “B” buttons to move forward or backward through the available modes. The mode may be either selected actively by pressing the “D” button while the mode splash screen is being displayed or passively by waiting a predetermined period of time while the mode splash screen is being displayed.

Local Weather Mode

FIG. 8 illustrates a local weather mode 800, in accordance with aspects of the invention. Generally, the local weather mode is the default mode for the weather channel and provides the user with weather information for the user's local area.

The local weather mode includes current conditions, the current days forecast, a 3 day forecast and a number of optional weather fields the user's home region. According to one embodiment, weather for a single city is provided. Alternatively, one or more cities may be provided to the device.

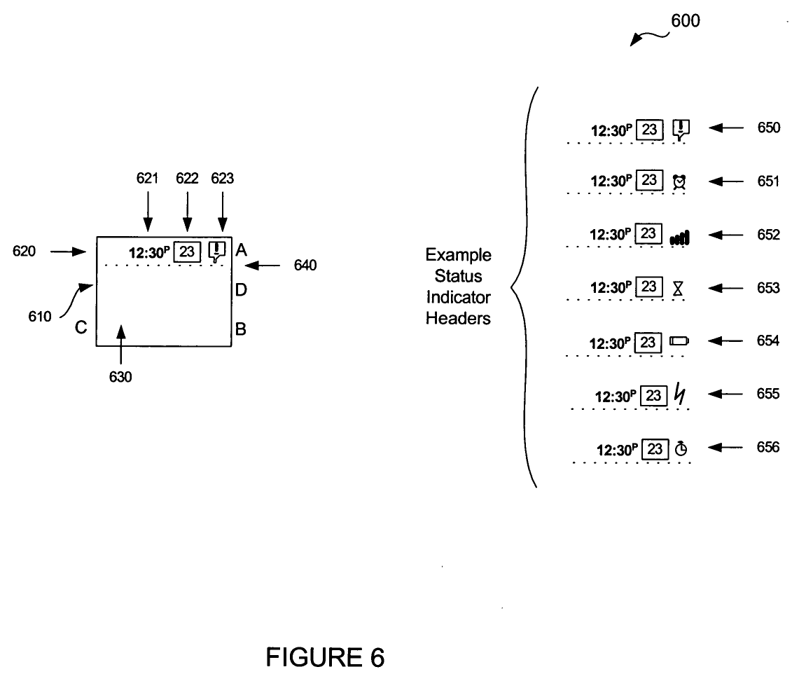

Each weather view may be partitioned into a header section (850), and a main body section (860). The header section may display the title of the current display, the current time or date, or some other information (See FIG. 6 and related discussion). After a predetermined delay time, the header section of the display screen may change from the one header view to another header view. After another predetermined delay time, the header section of the display screen may change back to the first header view. The toggling of the display section may be referred to as a passive interaction that is activated by “parking” the electronic device. The passive interaction is deactivated by activation of one or more selectors on the electronic device.

The displays may be manually changed by activation of the “A” (Previous) or “B” (Next) buttons. According to one embodiment, the displays automatically switch from one display to another display after a predetermined period of time. For example, each display may be shown for ten seconds before the next display is shown.

The local weather mode includes many different displays. Display 812 shows the current weather conditions for the user's local city. As shown, display 812 includes a graphical icon displaying the sky condition (sunny, partly cloudy, cloudy, rainy, thunderstorms, etc.), the name of the city and the current temperature.

Display 814 shows the current days forecast. As shown, display 814 includes the sky condition for the daytime hours and the sky condition for the night time hours, along with the high and low forecast temperatures. Header region 813 illustrates the title changing to show the time. As discussed herein, the header region may show different content at different times.

Display 816 shows the three day forecast for the local city. The local 3 day forecast includes the sky conditions for each day along with the high and low temperatures for each day. According to one embodiment, temperatures 817 alternate between the high and the low for the day. For example, for one predetermined period of time (i.e. 3 seconds) the high temperatures are shown and then the low temperatures are displayed for a predetermined period of time.

Displays 818, 820, 822, and 824 illustrate exemplary optional weather fields that may be provided. Many other weather fields may also be included. For example, wind direction, wind chill, and barometric pressure may be shown. As illustrated, display 818 shows the relative humidity, displays 820 and 822 shows the sunrise and sunset times, and display 824 illustrates the UV index.

My Cities Mode

FIG. 9 illustrates a My Cities mode 900, in accordance with aspects of the invention. The My Cities mode includes a list of cities selected by a user from the National and International city lists. The My Cities mode allows a user to select cities in which they are particularly interested in without having to scroll through the entire list of National or International cities that are provided in the National mode and the International mode. The user selects a predetermined number of cities on which to receive weather information. According to one embodiment, the user selects up to 10 different cities to be included in the My Cities mode.

After selecting the My Cities mode, the user is provided with the first city in their list. The user may then use the next (“B”) and previous (“A”) buttons to select the city they are interested in viewing.

Each display includes a header section and a main body section. The header section may display a title, the time, or some other information. If the user has not selected any cities to be included in the My Cities mode, the device does not show splash screen 910.

North America and International Weather Modes

FIGS. 10 and 11 illustrate a North America weather mode 1000 and an International weather mode 1100, in accordance with aspects of the invention. The North America mode includes weather information for a list of cities located within North America. The International weather mode includes weather information for a list of international cities. The following describes the operation for both of the modes.

The North America mode and the International mode are displayed as a list of cities. The list is sorted in alphabetical order by city name and is arranged in a circular fashion. In other words, selecting the “next” button (button “B”) from the last city selects the first city and selecting the “previous” button (button “A”) from the first city selects the last city contained within the list. As can be seen by the figures, the list view shows two cities per display page. For each city, the high and low temperature is displayed. According to another embodiment, the high and low temperatures are displayed alternately with a text description that indicates the sky condition of the city (clear, partly cloudy, cloudy, rain, thunder, etc.). Box 1040 includes displays 1042 and 1044 which alternate showing the temperatures and the sky condition. The temperatures and sky condition are alternated at a predetermined frequency (i.e. every 3 seconds).

The user may also perform a speed browse operation that allows the user to quickly go through the list of available cities. Holding down the “A” button or the “B” button for a predetermined time enters the speed browse function. When the user first drops into the list view mode, the first city is automatically selected. The user can select the next selection down in the list by selecting the “B” (next) button. If the user is on the bottom selection of the screen and presses the “B” button, the new selection remains at the bottom while the rest of the list appears to scroll up. The behavior is similar when the user presses “A” (previous) button while the top item on the page is selected. Scrolling happens one item at a time unless the user is in speed browse mode.

When the channel enters speed browsing, the display is grayed out and a large box (1020) appears in the middle of the screen with the first letter of the next item that doesn't start with the same letter as the current item. When the user is holding down the “B” button, the “next” first letter is selected. When the user is holding down the “A” button the “previous” letter is selected. As long as the user is holding down the “A” or “B” button, the letter changes at a predetermined interval (i.e. every 0.25 seconds) to the “next first letter” or “previous letter” in alphabetical order. If there are no cities that begin with that letter, that letter is skipped. When the user releases the button, the first city (alphabetically) that begins with the letter that was showing when the button was released is selected and displayed at the top of the screen. In the example illustrated in FIG. 10, the user has held the button until the “S” appeared in box 1020 thereby showing display 1030. Since the list is circular, “next” from “Z” goes to “A.” When the user releases the button, the first city with the letter in box 1020 is displayed. According to the present example, Sacramento and Salt Lake City were the first two cities in the North American list starting with an “S.”

Weather Notifications

Weather notifications may also be delivered to the device. According to one embodiment of the invention, the weather notifications are delivered to the device and displayed under a Message channel (not shown). The weather notifications may also be displayed in the weather channel. For example, a notification mode may be included in the weather channel.

Weather notifications help to provide users with updates on significant changes to the weather forecast or the existence of hazardous weather conditions, including items such as: storm warnings, tornado warnings, flood warnings, hurricane warnings, winter storm warnings, high wind warnings, special marine warnings, and the like.

Some other items that may be included in the weather channel are: health alerts (UV and smog); travel alerts (storm warnings); weather for sporting events; and weather related items for specific recreational activities (gardening, golf, sailing, etc).

User Interface for Configuring the Weather Channel

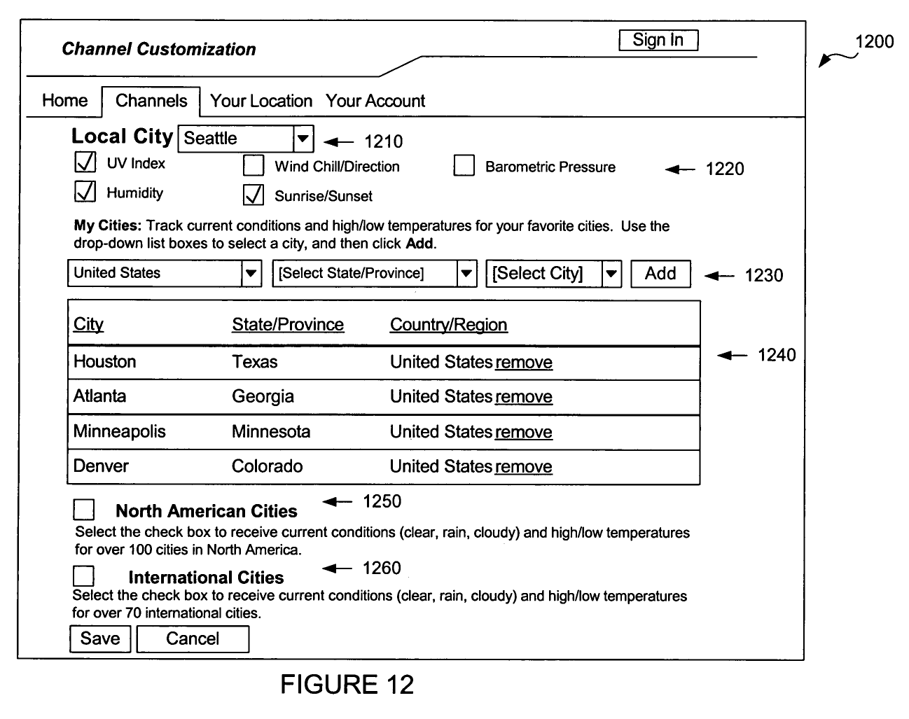

FIG. 12 illustrates a web user interface for inputting user preferences for a weather channel, in accordance with aspects of the invention.

Various weather options can be selected via a computer type interface such as through an internet based application, a computer based application, or any other reasonable method of accessing and altering configuration information. In one embodiment, a subscriber to the weather channel can accesses web page 1200 to select or change various features associated with the weather channel. In another embodiment, weather information already being tracked on a user's Internet home page may be retrieved and then used to populate the weather preferences for the weather channel. For example, the user's selected cities on their weather page may be used as their selected cities for the My Cities mode.

Dropdown list 1210 is populated with cities based on the user's home location. The city selected in dropdown list 1210 is used as the local city for the local weather mode.

Optional weather conditions (1220) may be selected by checking the appropriate checkbox next to the desired option. In the example illustrated, the user has selected to receive weather information including the UV index, humidity level, and sunrise/sunset information.

The user can add/change the selected cities within the My Cities mode by using dropdown lists 1230 and selecting the “Add” button. After the city is added, the city is added to list 1240.

When a user reaches a predetermined limit of cities the “Add” button is grayed out and text appears explaining that the number of cities selected is limited. According to one embodiment, the number of cities is limited to ten.

When the user clicks on a “remove” link next to the city, list 1240 refreshes and is displayed without that city. According to one embodiment, removing all of the cities from list 1240 and clicking “save” removes the My Cities mode from the Weather channel. In this instance, a configuration message is sent to the device causing the My Cities mode in the weather channel to be removed from the device.

The user may also select checkboxes 1250 and 1260 to turn on the North American and International modes. Once the user selects the “Save” button, the device is updated accordingly.

Data Feed and Encoding

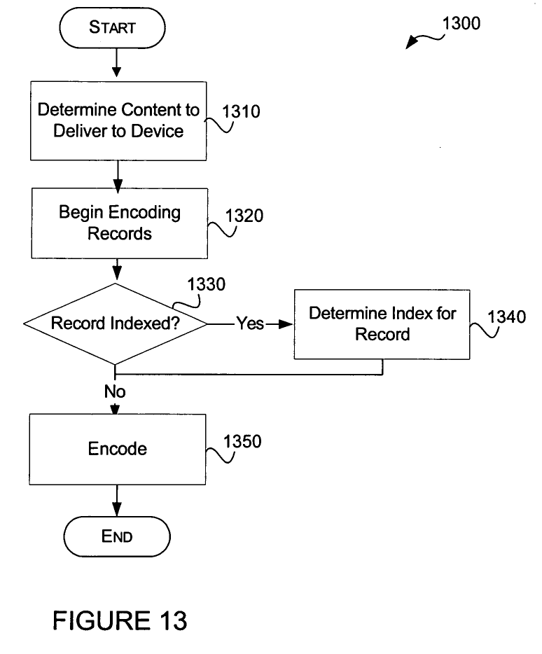

FIG. 13 illustrates encoding weather data, in accordance with aspects of the invention. After a start block, the process moves to block 1310 where a determination is made as to what content is going to be delivered to the device.

Moving to block 1320, the encoding process begins (See below for exemplary encoding).

Transitioning to decision block 1330, a determination is made as to whether the data record is part of an index. Generally, any information that is static and that is broadcast multiple times may be encoded as an index. For example, city names may be encoded as part of an index, such that each city name does not need to be delivered to the device each time the name is referenced. Indexing the content may cuts reduce the amount of data that needs to be broadcast. For example, sending each city name in the North American list or the International list each time would consume a large amount of bandwidth. The content may be indexed by assigning an ID to each city. According to one embodiment, the index starts at one and ends at the last city. The cities and their associated IDs may be delivered to the device in a configuration message such that when the device receives a weather channel broadcast the device may associate the ID with the city name.

When the record is encoded as an index, the process moves to block 1340, where the index value is determined for the record.

When the record is not encoded as an index, the process moves to block 1350, where the record is encoded. According to one embodiment, the value of the record is stored within a predetermined number of bits.

Exemplary Encoding

The following is an exemplary encoding obtained from the data feed for the current conditions and forecast sample from a weather data file for Seattle:
USWA0395,Seattle|WA|USA|United States|70|70|30|7|VAR|6||51|51|30.36|2|6|8|0||FEW||||||||5:55 am|8:32 pm|5|12:55|Aug. 08, 2002 16:40:00|5˜Aug. 8, 2002˜30˜4˜74˜0˜29˜4˜56˜0|6˜Aug. 9, 2002˜30˜4˜76˜0˜27˜3˜57˜0|7 Aug. 10, 2002˜28˜3˜71˜30˜29˜4˜55˜10|1˜Aug. 11, 2002˜30˜4˜72˜0˜29˜4˜53˜012˜Aug. 12, 2002˜30˜4˜75˜0˜29˜4˜54˜0

This format represents:
LocationID,City Name|State code|Country code|Region|Temperature|‘Feels Like’ temperature|Sky code|Numeric phrase identifier|Wind direction|Wind speed|Wind Gust|Relative humidity|Dew Point|Barometric pressure|Barometric pressure trend|UV Index|UV Index Phrase Id|UV Warning|Visibility|Clouds|Ceiling|Snow Incr|Total Snow|Snow Depth|Hourly Precip|Precip Amount (24 hr)|Sunrise|Sunset|Local Day Number|Local Time|Update Time|forecast day 0|forecast day 1|forecast day 2|forecast day 3|forecast day 4
   The forecast data is further broken down as: Day number˜Day date˜Sky code (Day)˜Numeric phrase idenitifier (day)˜High temperature˜Daytime precip probability˜Sky code (Night)˜Numeric phrase idenitifier (night)˜Low temperature˜Nighttime precip probability
   This format may be modified to reflect different weather broadcast information. Additionally, some of the data may be indexed. For example, the city name may be part of an index.
   Sky Code

According to one embodiment, the sky code is an index value into an array of forty eight different values. An exemplary mapping is as follows:

| | | | Text Instead of |
|---|---|---|---|
| Skycode | Our Icon | Icon Index | Icon |
| 0 | Thunder | 7 | |
| 1 | Rain | 3 | |
| 2 | Rain | 3 | |
| 3 | Thunder | 7 | |
| 4 | Thunder | 7 | |
| 5 | Snow | 4 | |
| 6 | snow | 4 | |
| 7 | Snow | 4 | |
| 8 | Rain | 3 | |
| 9 | Rain | 3 | |
| 10 | Rain | 3 | |
| 11 | Rain | 3 | |
| 12 | Rain | 3 | |
| 13 | Snow | 4 | |
| 14 | Snow | 4 | |
| 15 | Snow | 4 | |
| 16 | Snow | 4 | |
| 17 | Thunder | 7 | |
| 18 | Snow | 4 | |
| 19 | | | Dust |
| 20 | | | FOG |
| 21 | | | Haze |
| 22 | | | Smoke |
| 23 | | | Windy |
| 24 | | | Windy |
| 25 | | | Frigid |
| 26 | Cloudy | 2 | |
| 27 | Cloudy at night | 6 | |
| 28 | Partly Cloudy | 1 | |
| 29 | Cloudy at night | 6 | |
| 30 | Partly Cloudy | 2 | |
| 31 | Clear at night | 5 | |
| 32 | Clear | 0 | |
| 33 | Clear at night | 5 | |
| 34 | Partly Cloudy | 1 | |
| 35 | Thunder | 7 | |
| 36 | Clear | 0 | |
| 37 | Thunder | 7 | |
| 38 | Thunder | 7 | |
| 39 | Rain | 3 | |
| 40 | Rain | 3 | |
| 41 | Snow | 4 | |
| 42 | Snow | 4 | |
| 43 | Snow | 4 | |
| 44 | Partly Cloudy | 1 | |
| 45 | Rain | 3 | |
| 46 | Snow | 4 | |
| 47 | Thunder | 7 | |

As can be seen by referring to the table, sky code indexes 19-25 index to a text description instead of an icon indicator.

The following are exemplary encodings for broadcasting the weather information to the devices. The following is an exemplary encoding for local weather for the weather channel

| | Description (range | | |
|---|---|---|---|
| | of values) | Encoding | Bytes |
| Time Stamp | Date and Time this | Date and Time in | 2 bytes |
| | information was | UTC, rounded to | |
| | issued | the nearest 4 | |
| | | hours. | |
| City Identifier | Unique identifier for | Unsigned Integer | 2 bytes |
| | the city | | |
| City Name | Name of the city | String | Varies |
| Current Weather | Current Weather | Bitfield | 4 bits |
| | State | | (0.5 bytes) |
| Current | Current temperature | Signed Byte | 1 byte |
| Temperature | in Fahrenheit (−127 F. | | |
| | to 127 F.). Can also | | |
| | indicate temperature | | |
| | is not available. | | |
| Forecast for the | Forecast for today's | Bitfield | 4 bits |
| today | Weather State | | |
| High/Low | Today's high and | Signed Bytes | 2 bytes |
| | low temperatures. | | |
| | Temperature ranges | | |
| | from −127 F. | | |
| | to 127 F.. | | |
| | Can also indicate | | |
| | temperature is not | | |
| | available. | | |
| Forecast for | Forecast for | Bitfield | 4 bits |
| tonight | Tonight's Weather | | |
| | State | | |
| Forecast for next | Forecast of Weather | Bytes | 7.5 bytes |
| three days | State, high and low | | |
| | temperature for | | |
| | three days. | | |
| | Temperatures range | | |
| | −127 F. to 127 F.. Can | | |
| | also indicate | | |
| | temperature is not | | |
| | available. | | |
| Humidity | Current Humidity | Byte | 1 byte |
| | 0 . . . 100% | | |
| Sunrise | Time of sunrise in | Bitfield | 12 bits |
| | local time, accurate | | |
| | to the minute. | | |
| Sunset | Time of sunset in | Bitfield | 12 bits. |
| | local time, accurate | | |
| | to the minute. | | |
| Pressure trend | Barometric pressure | Bitfield | 2 bits |
| | trend. Steady, | | |
| | Rising, Falling or | | |
| | Not Available | | |
| Pressure | Barometric preasure. | Unsigned Integer | 2 bytes |
| | 0″ to 655.34″, or not | representing | |
| | available. | barometric | |
| | | pressure | |
| | | *100 | |
| Altitude in feet | Reference altitude | Integer | 2 bytes |
| | for barometric | | |
| | pressure reading. | | |
| | −32,768 . . . | | |
| | 32,768 feet | | |
| Wind direction | Wind direction. | Bytes | 5 bits |
| | Any of 16 compass | | |
| | directions, Calm, | | |
| | Variable, or Not | | |
| | available | | |
| Wind chill | Temperature with | Signed byte | 1 Byte |
| | wind chill, −127 to | | |
| | 127 degrees | | |
| | Fahrenheit. Can also | | |
| | indicate temperature | | |
| | is not available. | | |

The following is an exemplary encoding for regional weather for the weather channel

| | Description (range | | |
|---|---|---|---|
| Value | of values) | Encoding | Bytes |
| City Identifier | Unique Identifier for | Unsigned Integer | 2 Bytes |
| | a City | | |
| City Name | Name of city | String | Varies |
| Today's Forecast | Forecast of Weather | Bytes | 7.5 Bytes |
| | State, high | | |
| | temperature and low | | |
| | Temperature. | | |
| | Temperatures range | | |
| | −127 F. to 127 F.. | | |

The following is an exemplary encoding for national/international weather for the weather channel

| | Description (range | | |
|---|---|---|---|
| Value | of values) | Encoding | Bytes |
| City Identifier | Identifier for city | Index Bytes | 0 Bytes |
| Today's Forecast | Forecast of Weather | | 7.5 bytes |
| | State, high | | |
| | temperature and low | | |
| | Temperature. | | |
| | Temperatures range | | |
| | −127 F. to 127 F.. Can | | |
| | also indicate | | |
| | temperature is not | | |
| | available. | | |

Table of Weather State values

Not Available
Clear
Partly Cloudy
Cloudy
Rain
Snow
Clear at Night
Cloudy at Night
Thunder
Dust
Fog
Haze
Smoke
Windy
Frigid

Operating Environment

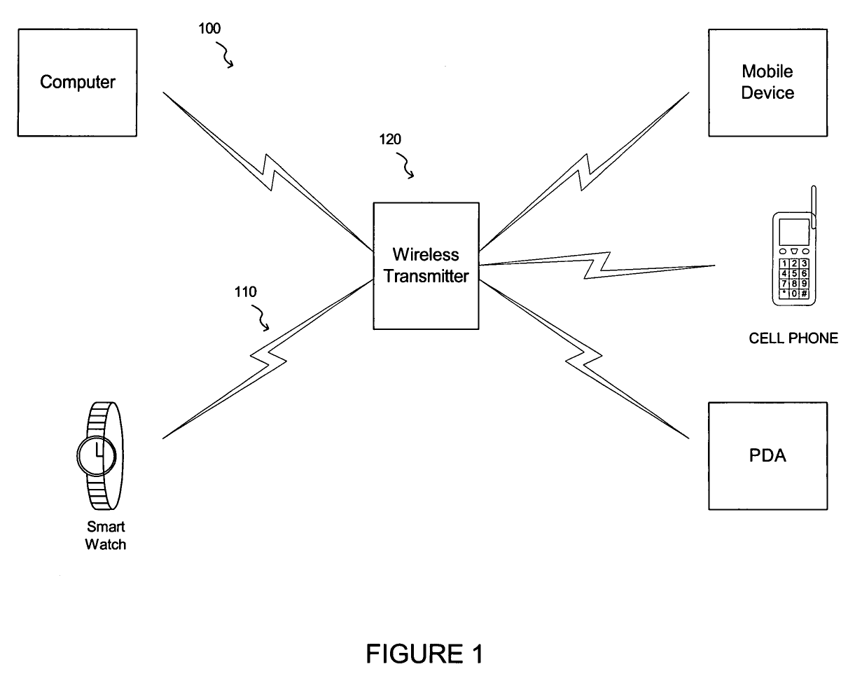

FIG. 1 illustrates an example operating environment for the present invention. As illustrated, operating environment 100 includes wireless transmitter 120 that is responsible for delivering content to wireless devices. According to one embodiment, the wireless transmitter may include a cellular tower that is used to communicate with mobile devices, such as cell phones, notebooks, pocket PCs, long-distance communication links, and the like. According to another embodiment, the wireless transmitter may include an FM transceiver that broadcasts signals over communication channel 110 to the various electronic devices. The FM broadcast may be any number of types including but not limited to: a standard FM transmission, a sub-carrier FM transmission, or any other type of FM transmission as may be desired. Example electronic devices that have an FM receiver or transceiver may include a desktop computer, a watch, a portable computer, a wireless cellular telephone (cell phone), and a personal data assistant (PDA). The electronic devices are arranged to receive information from the wireless broadcast.

Some example electronic devices that may include an electronic system arranged to operate according to the interaction model are illustrated in FIG. 1. Each of the electronic systems receives messages/information over the communication channel.

According to one embodiment, each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., a wireless watch device) receive message packets according to shared and private messages that are directed to the client device. Message packets are organized in groups according to logical slot (or channel) entry numbers. For example, a particular electronic device is configured to receive a selected group of channels from the available channels. The message packets associated with each of those channels is received, processed, and stored in the client device. The stored message packets can be reviewed using a user interface that employs an interaction model, in accordance with the present invention.

Example channels include: a weather channel, a sports channel, a time channel, a messages channel, a calendar channel, a stocks channel, a news channel, and a movies channel. Messages associated with each channel include message content that is based on the particulars of the channel. For example, the weather channel may include local weather information along with national and international weather.

FIG. 2 is a schematic diagram illustrating functional components of an illustrative electronic device that may be used to interact with channel content, in accordance with aspects of the invention. Electronic device 200 includes processor 260, memory 262, display 228, and user interface 232. Memory 262 generally includes both volatile memory (e.g., RAM) and non-volatile memory (e.g., ROM, Flash Memory, or the like). Electronic device 200 may include an operating system 264, such as the Windows CE operating system from Microsoft Corporation or another operating system, which is resident in memory 262 and executes on processor 260. User interface 232 may be a series of push buttons, a scroll wheel, a numeric dialing pad (such as on a typical telephone), or another type of user interface means. Display 228 may be a liquid crystal display, or any other type of display commonly used in electronic devices. In one example, display 228 may be touch-sensitive that would act as an input device.

One or more application programs 266 are loaded into memory 262 and run on the device. Examples of application programs include weather programs, sports programs, calendar programs, movie programs, time programs, and so forth. Electronic device 200 also includes non-volatile storage 268 that is located within memory 262. Non-volatile storage 268 may be used to store persistent information which should not be lost if electronic device 200 is powered down. Applications 266 may use and store information in storage 268, such as weather content used by a weather application, appointment information used by a calendar program, and the like.

Electronic device 200 includes power supply 270, which may be implemented as one or more batteries. Power supply 270 might further include an external power source, such as an AC adapter or a powered docking cradle that supplements or recharges the batteries.

Electronic device 200 is also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived content. Electronic device 200 can control each alert mechanism separately (e.g., audio, vibration, as well as visual cues).

Electronic device 200 also includes a communication connection, such as radio interface layer 272, which performs the function of receiving and/or transmitting radio frequency communications. Radio interface layer 272 facilitates wireless connectivity for electronic device 200. Transmissions to and from radio interface layer 272 are conducted under control of the operating system 264. In other words, communications received by radio interface layer 272 may be disseminated to application programs 266.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are included within the scope of computer readable media.

In one example of the present invention, electronic device 200 is a mobile electronic device such as a watch device that includes a wireless interface. An exemplary watch device is shown in FIG. 3.

Broadcast Channels

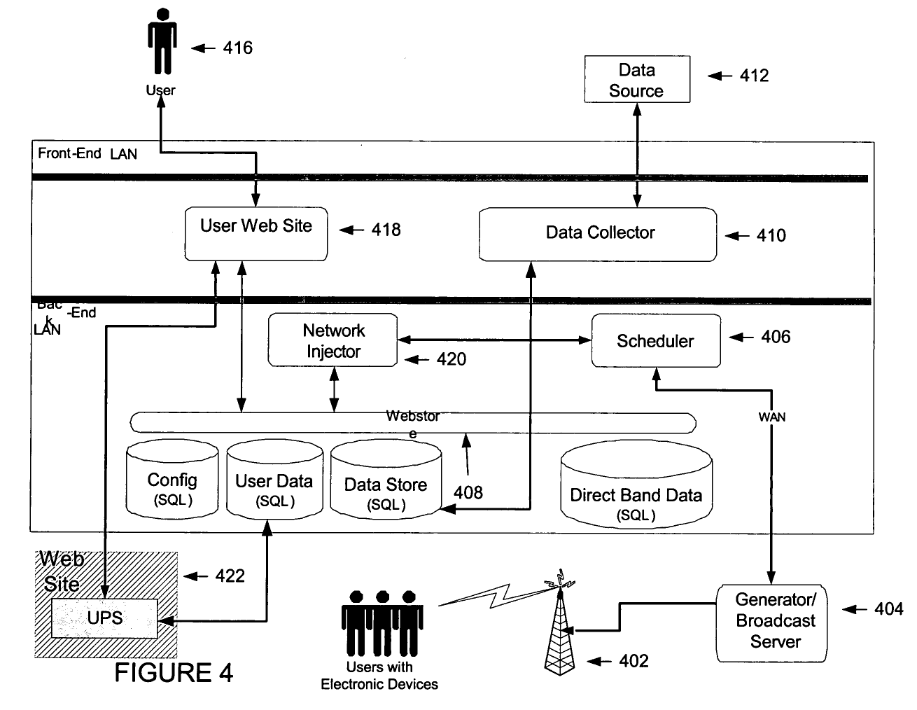

FIG. 4 illustrates a system for delivering and configuring channel information to an electronic device, in accordance with aspects of the invention.

A user, such as user 416, may customize their channels through user web site 418. Using website 418 the user may set options and select information associated with channels to which they have subscribed. For example, the user may select the cities they desire to receive weather information on using website 418. The selected options are stored in a data store, such as webstore 408. Channel information and various options may also be automatically retrieved from a web site to which the user participates in. For example, web site 422 may be the user's home page in which the user has already selected various options customizing their page. These options may be used to populate the options associated with various channels. For example, a user's selected cities may be used in a weather channel, the user's selected theaters may be used in a movies channel, a user's selected stocks they desire to track may be used in a stock channel, and the like.

Data Collector 410 is configured to collect data from one or more data sources, such as data source 412, relating to a channel. For example data collector 410 may retrieve weather forecast content from one data source, and weather alert content from another data source. According to one embodiment, the data feed for the weather channel is obtained from the The Weather Channel®.

The data obtained varies depending on the weather content that is delivered to the device. After the data is obtained, the data is encoded and then sent to the device. The data collected by data collector 410 may be stored in a data store, such as webstore 408, for later broadcast.

Broadcast transmitter tower 402 is arranged to provide a communication signal that is configured for reception by users with electronic devices that are located within a service region. Broadcast tower 402 transmits in response to generator/broadcast server 404. Generator 404 may communicate with scheduler 406 via a network communication link. Scheduler 406 is configured to schedule broadcast transmissions relating to channel information.

Selected services are entered in a database, such as webstore 408 for broadcast transmission at a later time. At the designated time (or time interval) scheduler 406 communicates with broadcast server 404 to begin a transmission sequence of data for the selected services. Broadcast server 404 converts the data to the appropriate format for transmission (i.e. an FM signal) and relays it to broadcast tower 402. In an alternative example, scheduler 406 communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region receives the shared and personal messages. Personal messages, however, may only be decoded by a single client.

Each frame includes a header, a table of contents, and a message payload that includes the content for one or more selected services as previously described. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust any time related information. Moreover, the time and date functions of the client device may be synchronized based on information that is included in the broadcast transmissions.

City names included within the North American and International lists change fairly rarely and therefore may be sent by broadcast server 404 as part of the configuration of the weather channel on the electronic device. The electronic device stores the name and corresponding ID of the name such that when it receives a weather broadcast transmission the device may match the ID with the name of the city. According to one embodiment, a stream of cities is broadcast at predetermined intervals. When a device needs a city, the city is accessed within the stream by an index value. According to another embodiment, whenever a city changes a configuration message is prepared and sent to the devices.

Updates to Device

According to one embodiment, the weather content expires each day at 2AM even if new weather content has not arrived. The new data is broadcast at predetermined intervals. According to one embodiment, the content begins each day at 12:00 midnight local time. If the device is out of reception and does not acquire the new day's data, the channel will display a No Data message.

Broadcast throughout the day are used to update the weather content. The local weather information is broadcast more frequently than the forecast data delivered in the North American and International modes. According to one embodiment, the local weather information is broadcast 4-5 times an hour, and the forecast data is updated one time an hour. Each captured weather broadcast completely replaces any earlier weather broadcast.

When the user is roaming, the device will receive weather information based on the region in which they are traveling.

Process Flow

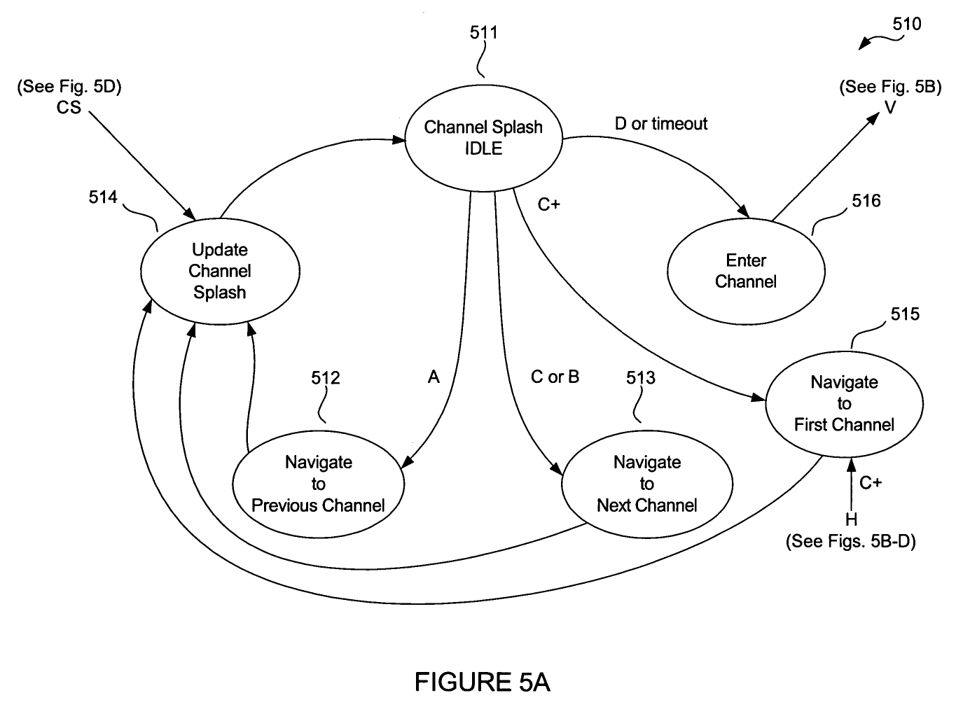

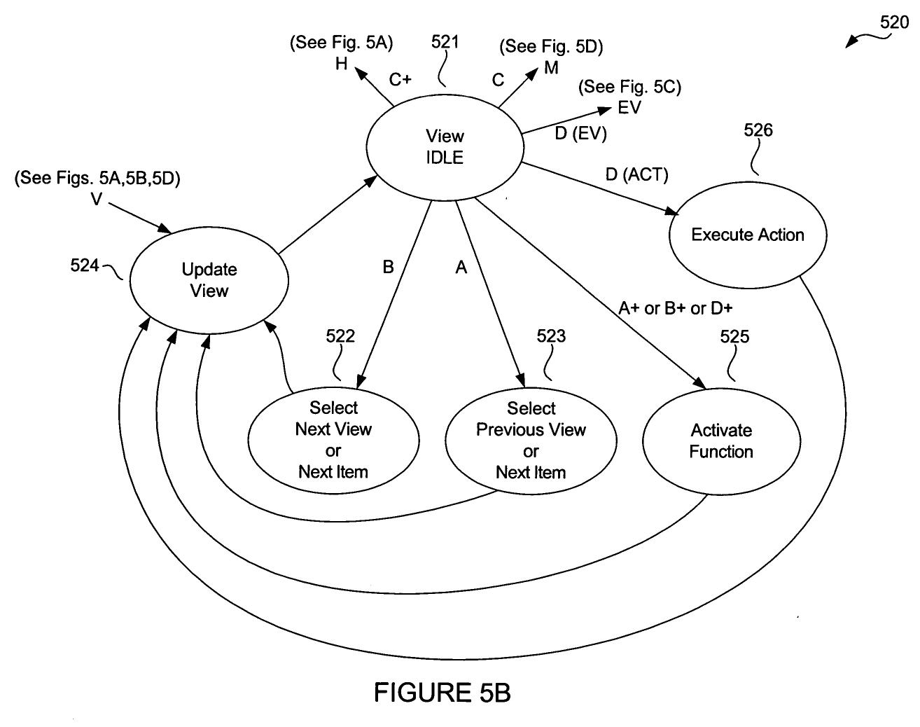

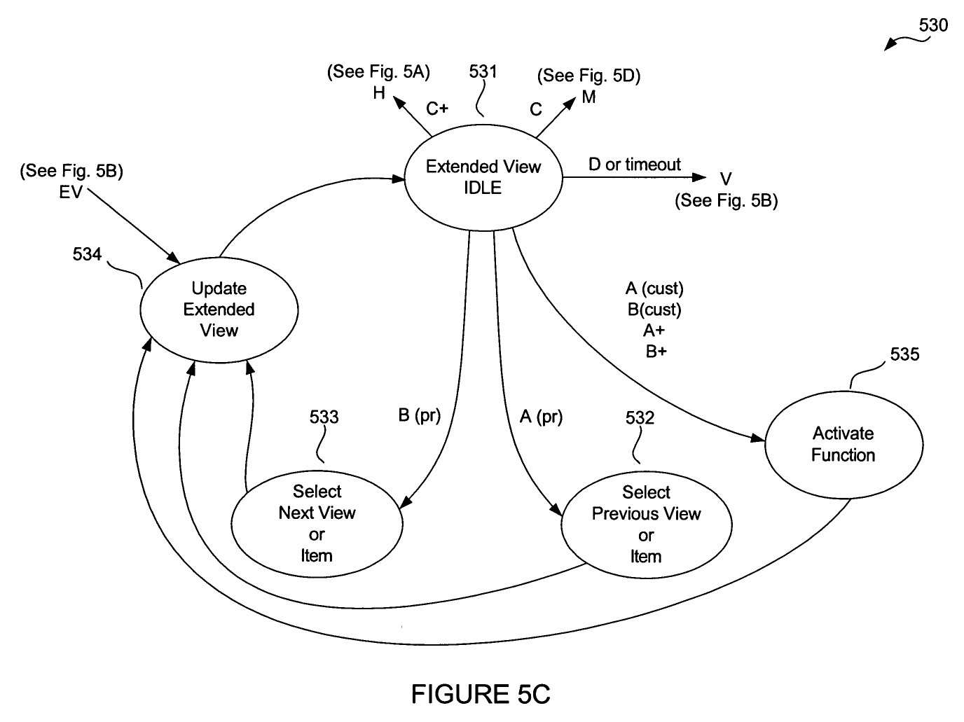

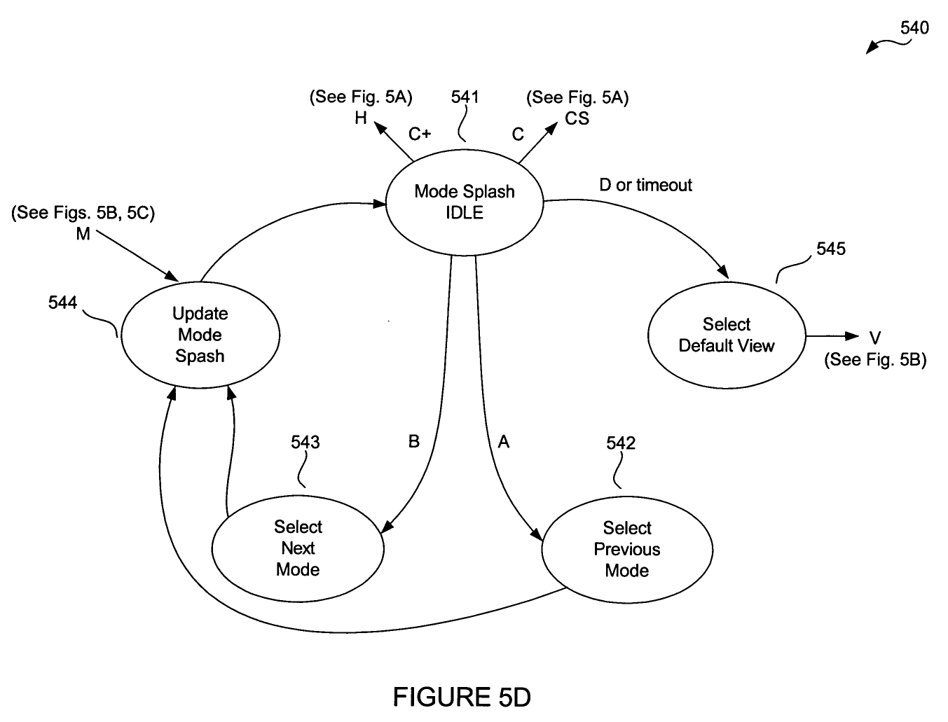

Process flow diagrams for navigation function of an example electronic device are illustrated in FIGS. 5A-5D. The process flow diagram illustrated in FIG. 5A is predominately focused on channel splash activity. The process flow diagram illustrated in FIG. 5B is predominately focused on view activity. The process flow diagram illustrated in FIG. 5C is predominately focused on extended view activity. The process flow diagram illustrated in FIG. 5D is predominately focused on mode splash activity.

Every electronic device has at least one channel that corresponds to the home channel. For a watch type of device, the home channel corresponds to a time channel. However, different home channels can be assigned to every electronic device. Whenever the currently selected channel corresponds to the home channel, the previous channel corresponds to the last channel (if more than one channel exists on the device). Similarly, the next channel corresponds to the home channel when the current channel is the last channel in the channel list for the electronic device.

Every electronic device has a set of selectors (or buttons) that are selectively activated to navigate various functions in the device. Example selectors are illustrated in FIG. 3. For the purposes of the discussion below, each selector is indicated by a letter such as “A”, “B”, “C”, “D”, and “E”. Some alternate selector functions may be chosen by sustained activation of a selector button for a predetermined time interval (e.g., two seconds). The alternate selector functions are generally indicated in the figures by a “+” symbol that is adjacent to the selector functions' designating letter (e.g., “C+”).

The example electronic device described below includes at least four selectors as indicated by letters “A”, “B”, “C”, and “D”. The “E” selector may be arranged to provide additional functions such as backlighting, a back channel selector, as well as any other desired function. Additional extended functions may also be programmed and accessible through multiple selector combinations. For example, one function could be selected by holding the “D” and “A” selectors together (“D+” & “A+”) for a predetermined time interval. Additional extended functions can also be programmed using other selector combinations such as “D+” & “B+”, “A+” & “B+”, as well as others.

Channel Splash Operating State

The channel splash operating state is described as follows below with reference to FIG. 5A.

The electronic device has a default initial channel that is referred to as a home channel. The display is updated to indicate the currently selected channel at block 514. Processing continues to block 511 where the channel splash operating state is maintained in an idle state. The electronic system in the electronic device monitors the user interface (e.g., the four selectors) while in the channel splash IDLE state. Processing leaves the channel splash IDLE state when the user activates one or more of the selectors or a timeout has occurred. The display actively maintains the splash screen to indicate the current channel selection while the channel splash IDLE state is active at block 511. Splash screens may include one or more graphic elements and/or text elements. An example channel splash screen for a weather channel is illustrated in FIG. 7. Splash screens may be accompanied by the activation of sound that provides an audible indicator that the channel has changed. The sound associated with the audible indicators may be the same for each channel splash screen, or unique based on either the particular channel or the particular channel type (e.g., news channels are one type, while messages are another type).

Processing flows from channel splash IDLE state 511 to the “navigate up” or “navigate to previous channel” function 512 when the “A” selector is activated. Processing continues from block 512 to block 514, where the display is updated based on the newly selected channel. After the display is updated, processing returns to channel splash IDLE state 511.

Processing flows from channel splash IDLE state 511 to the “navigate down” or “navigate to next channel” function 513 when either the “B” selector or the “C” selector is activated. Processing continues from block 513 to block 514, where the display is updated based on the newly selected channel. After the display is updated, processing again returns to channel splash IDLE state 511.

Processing flows from channel splash IDLE state 511 to the “navigate to first channel” or “navigate to home channel” function 515 when the “C+” selector is activated. The home channel navigation function can be accessed from any channel of the electronic device. The electronic device navigates to the home channel (e.g., the time channel on a watch device) when the “navigate to home channel” function is activated. Processing continues from block 513 to block 514, where the display is updated based on the newly selected channel (i.e., the home channel). After the display is updated, processing again returns to channel splash IDLE state 511.

Processing flows from the channel splash IDLE state 511 to the “enter channel” function 516 when the “D” selector is activated. Alternatively, the “enter channel” function is activated when the electronic system is maintained in the channel splash IDLE state for a predetermined time interval (e.g., a 2 second timeout) without activation of a selector. Processing flows from block 516 to block 524 (see FIG. 5B) when the “enter channel” function is activated as indicated by “V”.

The enter channel function performs a series of initializations in the electronic device prior to leaving the channel splash operating state and entering the channel view operating state. Every channel in the electronic device has at least one operating mode. The electronic device selects the current operating mode as a default mode, and a current view as a default view in the currently selected channel when the “enter channel” function is activated.

In one example, a weather channel has a local weather mode, a my cities mode, a North American mode, and an International mode. Multiple views may be associated with each operating mode.

Channel View Operating State

The channel view operating state is described as follows below with reference to FIG. 5B.

The electronic device enters the channel view operating state at entry point V, where the selector functions associated with the currently selected channel and operating mode are mapped to the selectors. The display is updated to indicate the currently selected view at block 524. Processing continues to block 521 where the channel view operating state is maintained in an IDLE state. The electronic system in the electronic device monitors the user interface (e.g., the four selectors) while in the view IDLE state. When the user activates one or more of the four selectors, processing leaves the view IDLE state.

The display actively maintains the current view while the view IDLE state is active at block 521. List type views include lists of items that can be selected. Other types of views are simply graphical and/or textual elements that are arranged in a display view. Views may be accompanied by the activation of sound that provides an audible indicator that the view has changed. The sound associated with the audible indicators may be the same for each view (e.g., a beep type of indicator or sound clip), or unique based on the particular view. In one example, an audible indicator is activated when a particular alert notification function is activated.

Processing flows from the view IDLE state 521 to the “previous view” or “previous item” function 522 when the “A” button selector is activated. Processing continues from block 522 to block 524, where the display is updated based on the newly selected view. After the display is updated, processing returns to view IDLE state 521. In one example, the previous view corresponds to the last view when the currently selected view is the first available view in the current mode for the current channel. In another example, the previous view corresponds to an empty view (e.g., “no weather”, “no data”, etc.) when the currently selected view is the first available view in the current mode for the current channel. In still another example, the previous item in a list is highlighted when the “A” selector is activated.

Processing flows from view IDLE state 521 to the “next view” or “next item” function 513 when the “B” selector is activated. Processing continues from block 523 to block 524, where the display is updated based on the newly selected view. After the display is updated, processing again returns to view IDLE state 521. In one example, the next view corresponds to the first view when the currently selected view is the last available view in the current mode for the current channel. In another example, the next view corresponds to an empty view when the currently selected view is the last available view in the current mode for the current channel. In still another example, the next item in a list is highlighted when the “B” selector is activated.

Processing flows from view IDLE state 521 to the “mode splash” function when the “C” selector (e.g., “mode select”) is activated as indicated by “M”. Refer to FIG. 5D and related discussion for details.

Processing flows from view IDLE state 521 to the select home channel splash function when the “C+” selector is activated as indicated by “H”. Refer to FIG. 5A and related discussion for details.

The “D” selector is defined within the context of the current channel, mode, and view. The “D” selector may be defined as a “delete” function, and “enter extended view” function, a “select” function, or an “execute action” function. Not every view in a given channel/mode has an extended view as may be indicated by a null value. Some views may have an action function that is defined within the context of the view in the currently selected mode/channel. The context for each view is assigned to the mode upon entry into the mode for the current channel.

Processing flows from the view IDLE state 521 to the “enter extended view” function when the “D” selector is activated and the extended view is available as indicated by “D(EV)”. The extended view is available when defined within the context of the currently selected view. For example, the extended view may be available for a list type view such that the highlighted list item is selected when the “D” selector is activated, and a detailed view associated with the highlighted item is displayed as an extended view. Refer to FIG. 5C and related discussion for details on the extended view processing.

Processing flows from view IDLE state 521 to the “execute action” function at block 526 when the “D” selector is activated and the action function is available as indicated by “D(ACT)”. The action function is defined within the context of the currently selected view. For example, a fortune cookie mode may be available in an entertainment channel. Although the fortune cookie mode may only have a single view, the “D” selector may be mapped to an action function that randomly selects fortunes from a list when the “D” selector is activated. After the action is performed (e.g., retrieve random fortune from list, execute an animation sequence), processing continues to block 524 where the display is updated as previously described.

Other special functions may be mapped to the “A+”, “B+”, and “D+” selectors within the context of the current view. By activating the corresponding selector for a predetermined time interval (e.g., 2 seconds) the corresponding special function is activated as indicated by block 525. Processing continues from block 525 to block 524 where the display is updated as previously described.

In one example, a list browser function is available in a mode that corresponds to cities. For this example, activation of the “A” and “B” selectors result in manual navigation through views that correspond to previous or subsequent stories. Activation of the “A+” or “B+” selector may activate a speed browse function.

In another example, a delete function may be available in a view that corresponds to a specific story or alert associated with the weather channel. Activation of the “D+” selector may activate a delete function that removes the currently selected story from the electronic device.

In still another example, processing may flow from view IDLE state 521 to an “alternate view” function when the electronic system is maintained in the channel splash IDLE state for a predetermined time interval (e.g., a 2 second timeout) without activation of a selector. For example, no action for a predetermined amount of time may result in views associated with the channel automatically rotating to other views associated with the channel.

Extended View Operating State

The extended view operating state is described as follows below with reference to FIG. 5C.

The electronic device enters the extended view operating state at entry point EV, where the selector functions associated with the currently selected extended view are mapped to the selectors. The display is updated to indicate the currently selected extended view at block 534. Processing continues to block 531 where the extended view operating state is maintained in an IDLE state. The electronic system in the electronic device monitors the user interface (e.g., the four selectors) while in the extended view IDLE state. When the user activates one or more of the four selectors, processing leaves the extended view IDLE state.

The display actively maintains the current extended view while the extended view IDLE state is active at block 531. Extended views include graphical and/or textual elements that are arranged in a display view. Extended views may be accompanied by the activation of sound that provides an audible indicator that the extended view has changed. The sound associated with the audible indicators may be the same for each extended view (e.g., a beep type of indicator or sound clip), or unique based on the particular extended view.

Processing flows from extended view IDLE state 531 to the “previous view” or “previous item” function 532 when the “A” selector is activated. Processing continues from block 532 to block 534, where the display is updated based on the newly selected extended view. After the display is updated, processing returns to extended view IDLE state 531. In one example, the previous view corresponds to the last extended view when the currently selected extended view is the first available extended view for the current channel/mode. In another example, the previous extended view corresponds to an empty view (e.g., “no appointments”, “no events”, “no data”, etc.) when the currently selected extended view is the first available extended view in the current channel/mode.

Processing flows from extended view IDLE state 531 to the “next view” or “next item” function 533 when the “B” selector is activated. Processing continues from block 533 to block 534, where the display is updated based on the newly selected extended view. After the display is updated, processing returns to the extended view IDLE state 531. In one example, the next view corresponds to the first extended view when the currently selected extended view is the last available extended view for the current channel/mode. In another example, the next extended view corresponds to an empty view (e.g., “no events”, “no data”, etc.) when the currently selected extended view is the last available extended view in the current channel/mode.

Processing flows from extended view IDLE state 531 to the “mode splash” function when the “C” selector (e.g., “mode select”) is activated as indicated by “M”. Refer to FIG. 5D and related discussion for details.

Processing flows from extended view IDLE state 531 to the view function when the “D” selector is activated as indicated by “V”. In another example, processing flows from extended view IDLE state 531 to the view function when a timeout interval expires (e.g., 5 seconds). Refer to FIG. 5B and related discussion for details concerning the view functions.

Processing flows from extended view IDLE state 531 to the select home channel splash function when the “C+” selector is activated as indicated by “H”. Refer to FIG. 5A and related discussion for details.

Special functions may be mapped to the “A′”, “B”, “A+”, and “B+” selectors within the context of the current view. By activating the corresponding selector for a predetermined time interval (e.g., a 2 second timeout interval) the corresponding special function is activated as indicated by block 535. Processing continues from block 535 to block 534 where the display is updated as previously described.

Mode Splash Operating State

The model splash operating state is described as follows below with reference to FIG. 5D.

The electronic device enters the mode splash operating state at entry point M. The display is updated to indicate the currently selected mode at block 545. Processing continues to block 541 where the mode splash operating state is maintained in an IDLE state. The electronic system in the electronic device monitors the user interface (e.g., the four selectors) while in the mode splash IDLE state. When the user activates one or more of the four selectors, processing leaves the mode splash IDLE state.

The display actively maintains the current mode splash display while the mode splash view IDLE state is active at block 541. Mode splash views include graphical and/or textual elements that are arranged in a display view.

Example mode splash displays for a weather channel are illustrated in FIG. 7. Mode splash displays may be accompanied by the activation of sound that provides an audible indicator that the selected mode has changed. The sound associated with the audible indicators may be the same for each mode splash (e.g., a beep type of indicator or sound clip), or unique based on the particular mode selected.

Processing flows from mode splash IDLE state 541 to the “previous mode” function 542 when the “A” selector is activated. Processing continues from block 542 to block 544, where the display is updated based on the newly selected mode. After the display is updated, processing returns to mode splash IDLE state 541. In one example, the previous mode corresponds to the last mode when the currently selected mode is the first available mode for the current channel.

Processing flows from mode splash IDLE state 541 to the “next mode” function 543 when the “B” selector is activated. Processing continues from block 543 to block 544, where the display is updated based on the newly selected mode. After the display is updated, processing returns to mode splash IDLE state 541. In one example, the next mode corresponds to the first mode when the currently selected mode is the last available mode for the current channel.

Processing flows from mode splash IDLE state 541 to the “channel splash” function when the “C” selector (e.g., “channel select”) is activated as indicated by “CS.” Refer to FIG. 5A and related discussion for details.

Processing flows from mode splash IDLE state 541 to the “select default view” function 545 when the “D” selector is activated. Alternatively, processing may flow from mode splash IDLE state 541 to the “select default view” function 545 when a timeout interval (e.g., a 2 second interval) has expired. Processing continues from block 545 to the channel view operating state as indicated by “V”. Refer to FIG. 5B and related discussion for details.

Processing flows from mode splash IDLE state 541 to the select home channel splash function when the “C+” selector is activated as indicated by “H”. Refer to FIG. 5A and related discussion for details.

Example Display Screen Partitions

FIG. 6 shows exemplary status indicator headers, in accordance with aspects of the present invention. Example display screen 610 is partitioned into two regions: header region 620 and main body region 630.

Main body region 630 of display screen 610 may include one or more graphical and/or textual information fields that change based on the current context in the current channel, mode, and operating state. In one example context, main body region 630 is a single region for displaying textual information, such as textual information 612. In another example context, main body section 610 may include a graphical representation.

Header region 620 of display screen 610 may include one or more graphical and/or textual information fields that change based on the current context in the current channel, mode, and operating state. In one example context, header region 620 may include two regions: current time field 621 and current date field 622. In another example context, header region 620 may include three regions: current time field 621, current date field 622, and status indicator field 623. In still another example context, header region 620 may include information relating to the channel. For example, the name of a team or player may be displayed in header region 620.

Status indicators may be associated with various conditions such as alerts in the electronic device. Example header 650 includes a status indicator for an internal alert such as an exclamation point symbol. Example header 651 includes a status indicator that an alarm is set such as an alarm clock symbol. Example header 652 includes a status indicator of signal strength in a wireless connection such as signal strength bars. Example header 653 includes a status indicator that a timer is running such as an hourglass symbol. Example header 654 includes a status indicator that the battery is low such as an empty battery symbol. Example header 655 includes a status indicator that the battery is charging such as a lightning bolt symbol. Example header 656 includes a status indicator that a timer is running such as a chronograph symbol. Other headers may also be used.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for receiving, displaying and interacting with weather channel content on a mobile electronic device, comprising:
receiving the weather channel content encoded on a communication signal that is broadcast to many electronic devices;
storing at least a portion of the weather channel content on the electronic device;
associating the weather channel content with a weather channel application on the electronic device;
setting a current view associated with the weather channel; and
displaying the current view on a display of the electronic device.

2. The method of claim 1, wherein setting the current view further comprises setting the current view to at least one of: a current local weather view; and a list of cities along with weather information.

3. The method of claim 1, wherein setting the current view associated with the weather channel, further comprises selecting a mode, wherein the mode is selected from at least one of: a local weather mode; a my cities mode; a North American mode; and an International mode.

4. The method of claim 3, further comprising setting the current view to display: a local weather display when the local weather mode is selected; user selected cities when the my cities mode is selected; a list of North American cities when the North American mode is selected; and a list of International cities when the International mode is selected.

5. The method of claim 3, further comprising receiving an input indicating a selection associated with one of the modes; and in response to the selection setting the current view.

6. The method of claim 2, further comprising determining when a detail view is selected; and in response to the detail view being selected showing details associated with the selected detail view.

7. The method of claim 6, wherein showing details further comprises showing a current weather view.

8. The method of claim 5, further comprising automatically receiving updates to the weather channel content throughout a day.

9. The method of claim 1, further adjusting the current view based on user preferences.

10. The method of claim 2, further comprising automatically alternating weather information within the current view.

11. An apparatus for receiving, navigating, and displaying weather content, comprising:
a data store;
a communication connection configured to receive a communication signal including the weather content that is directed to a plurality of mobile electronic devices and store the weather content in the data store;
a display;
a user interface that includes a selector; and
an electronic system that is arranged to interact with the user interface, the data store, the communication connection, and the display, wherein the electronic system is configured to:
select a current view from at least one of the set of views including: a local weather view; a my cities view; and a cities view; and
display the current view on the display.

12. The apparatus of claim 11, wherein the electronic system is further configured to select a details view associated with the current view in response to the selector.

13. The apparatus of claim 11, wherein the local weather view includes local weather information associated with a user.

14. The apparatus of claim 11, wherein the electronic system is further configured to activate a city list in response to the interface selection device, wherein the city list is organized as a list of cities having associated weather information.

15. The apparatus of claim 11, wherein the electronic system is further configured to activate a user selected city list in response to the interface selection device, wherein the user selected city list is organized as a list of cities having associated weather information.

16. The apparatus of claim 14, wherein the electronic system is further configured to automatically receive the communication signal including the weather content that includes updates to the weather content.

17. The apparatus of claim 12, further comprising adjusting the weather content received by the device based on user preferences.

18. A system for providing and interacting with weather content, comprising:
a data collector configured to collect the weather content associated with a weather channel;
a broadcast device configured to transmit a communication signal including the weather content to a plurality of mobile electronic devices at the same time;
a mobile electronic device, having:
a data store;
a communication connection configured to receive the communication signal and store the weather content in the data store;
a display;
a user interface that includes a selector; and
an electronic system that is arranged to interact with the communication connection, the user interface, the data store and the display, wherein the electronic system is configured to:
select a current view associated with the weather channel;
change the current view in response to the selector; and
display the current view on the display.

19. The system of claim 18, wherein the weather content includes at least one of the following: local weather information; North American weather information, and International weather information.

20. The system of claim 19, wherein the electronic system is further configured to a detailed weather view associated with a selected city.

21. The system of claim 18, wherein the broadcast device is configured to broadcast an FM communication signal.

22. The system of claim 18, further comprising a server configured to receive user preferences associated with users receiving the weather channel; wherein the user preferences include preferences related to at least one of the following: cities and weather information.
